(19) United States
(12) Patent Application Publication
(10) Pub. No.: US 2017/0019934 A1
(43) Pub. Date: Jan. 19, 2017

(54) BUFFER STATUS REPORTING DURING MULTIMEDIA SERVICE CALL SETUP

(71) Applicant: QUALCOMM Incorporated, San Diego, CA (US)

(72) Inventors: Ming YANG, San Diego, CA (US); Tom CHIN, San Diego, CA (US)

(21) Appl. No.: 14/801,791

(22) Filed: Jul. 16, 2015

(51) Int. Cl. H04W 76/02; H04W 72/12; H04L 29/12

(52) U.S. Cl. CPC H04W 76/02; H04L 61/1529; H04W 72/1205; H04W 88/005

(57) ABSTRACT

A method and system for wireless communications at a user equipment utilizes buffer status reporting during call setup, including voice-over IP (VoIP) call setup. The UE determines it has no data in a data buffer to send during a call setup. The UE then sends a first scheduling request and a non-zero buffer status for the data buffer during the call setup before a data inactivity timer expires.

### BACKGROUND

Field

Aspects of the present disclosure relate generally to wireless communication systems, and more particularly, to utilizing buffer status reporting during call setup, including voice-over IP (VoIP) call setup.

Background

Wireless communication networks are widely deployed to provide various communication services, such as telephony, video, data, messaging, broadcasts, and so on. Such networks, which are usually multiple access networks, support communications for multiple users by sharing the available network resources. One example of such a network is the universal terrestrial radio access network (UTRAN). The UTRAN is the radio access network (RAN) defined as a part of the universal mobile telecommunications system (UMTS), a third generation (3G) mobile phone technology supported by the 3rd Generation Partnership Project (3GPP). The UMTS, which is the successor to global system for mobile communications (GSM) technologies, currently supports various air interface standards, such as wideband-code division multiple access (W-CDMA), time division-code division multiple access (TD-CDMA), and time division-synchronous code division multiple access (TD-SCDMA). For example, China is pursuing TD-SCDMA as the underlying air interface in the UTRAN architecture with its existing GSM infrastructure as the core network. The UMTS also supports enhanced 3G data communications protocols, such as high speed packet access (HSPA), which provides higher data transfer speeds and capacity to associated UMTS networks. HSPA is a collection of two mobile telephony protocols, high speed downlink packet access (HSDPA) and high speed uplink packet access (HSUPA) that extends and improves the performance of existing wideband protocols.

As the demand for mobile broadband access continues to increase, there exists a need for further improvements in wireless technology. Preferably, these improvements should be applicable to LTE and other multi-access technologies and the telecommunication standards that employ these technologies.

### SUMMARY

In one aspect, a method of wireless communications at a user equipment (UE) is disclosed. The method includes determining the UE has no data in a data buffer to send during a call setup. The method also includes sending a first scheduling request and a non-zero buffer status for the data buffer during the call setup before a data inactivity timer expires.

Another aspect discloses an apparatus for wireless communications at a user equipment. The apparatus has a memory and at least one processor coupled to the memory. The processor(s) is configured to determine the UE has no data in a data buffer to send during a call setup. The processor(s) is also configured to send a first scheduling request and a non-zero buffer status for the data buffer during the call setup before a data inactivity timer expires.

In another aspect, a computer program product for wireless communications in a wireless network having a non-transitory computer-readable medium is disclosed. The computer-readable medium has non-transitory program code recorded thereon which, when executed by the processor(s), causes the processor(s) to perform operations of determining the UE has no data in a data buffer to send during a call setup. The program code also causes the processor(s) to send a first scheduling request and a non-zero buffer status for the data buffer during the call setup before a data inactivity timer expires.

Another aspect discloses an apparatus including means for determining the UE has no data in a data buffer to send during a call setup. The apparatus also includes means for sending a first scheduling request and a non-zero buffer status for the data buffer during the call setup before a data inactivity timer expires.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a diagram illustrating an example of a network architecture.

FIG. 2 is a diagram illustrating an example of a downlink frame structure in long term evolution (LTE).

FIG. 3 is a diagram illustrating an example of an uplink frame structure in long term evolution (LTE).

FIG. 4 is a block diagram conceptually illustrating an example of a base station in communication with a user equipment (UE) in a telecommunications system.

FIG. 5 is a block diagram of an internet multimedia subsystem (IMS) architecture.

FIG. 6 is a flow diagram illustrating a method for multimedia service call setup over an IP network according to one aspect of the present disclosure.

FIG. 7 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

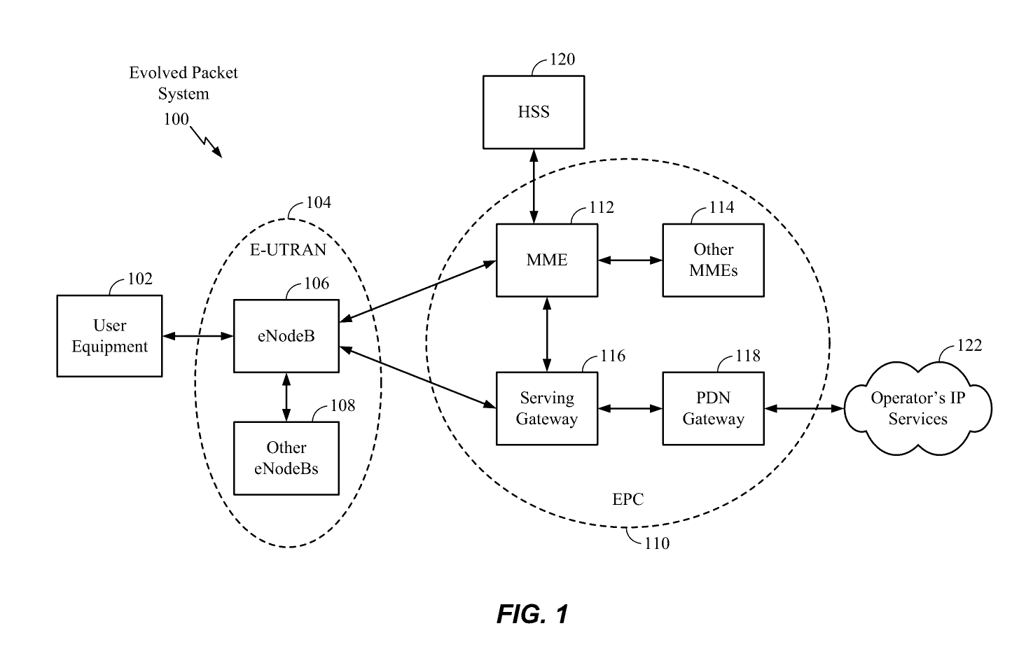

FIG. 1 is a diagram illustrating a network architecture 100 of a long-term evolution (LTE) network. The LTE network architecture 100 may be referred to as an evolved packet system (EPS) 100. The EPS 100 may include one or more user equipment (UE) 102, an evolved UMTS terrestrial radio access network (E-UTRAN) 104, an evolved packet core (EPC) 110, a home subscriber server (HSS) 120, and an operator's IP services 122. The EPS can interconnect with other access networks, but for simplicity those entities/interfaces are not shown. As shown, the EPS 100 provides packet-switched services, however, as those skilled in the art will readily appreciate, the various concepts presented throughout this disclosure may be extended to networks providing circuit-switched services.

The E-UTRAN 104 includes an evolved Node B (eNodeB) 106 and other eNodeBs 108. The eNodeB 106 provides user and control plane protocol terminations toward the UE 102. The eNodeB 106 may be connected to the other eNodeBs 108 via a backhaul (e.g., an X2 interface). The eNodeB 106 may also be referred to as a base station, a base transceiver station, a radio base station, a radio transceiver, a transceiver function, a basic service set (BSS), an extended service set (ESS), or some other suitable terminology. The eNodeB 106 provides an access point to the EPC 110 for a UE 102. Examples of UEs 102 include a cellular phone, a smart phone, a session initiation protocol (SIP) phone, a laptop, a notebook, a netbook, a smartbook, a personal digital assistant (PDA), a satellite radio, a global positioning system, a multimedia device, a video device, a digital audio player (e.g., MP3 player), a camera, a game console, or any other similar functioning device. The UE 102 may also be referred to by those skilled in the art as a mobile station or apparatus, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNodeB 106 is connected to the EPC 110 via, e.g., an S1 interface. The EPC 110 includes a mobility management entity (MME) 112, other MMEs 114, a serving gateway 116, and a packet data network (PDN) gateway 118. The MME 112 is the control node that processes the signaling between the UE 102 and the EPC 110. Generally, the MME 112 provides bearer and connection management. All user IP packets are transferred through the serving gateway 116, which itself is connected to the PDN gateway 118. The PDN gateway 118 provides UE IP address allocation as well as other functions. The PDN gateway 118 is connected to the operator's IP services 122. The operator's IP services 122 may include the Internet, the Intranet, an IP multimedia subsystem (IMS), and a PS streaming service (PSS).

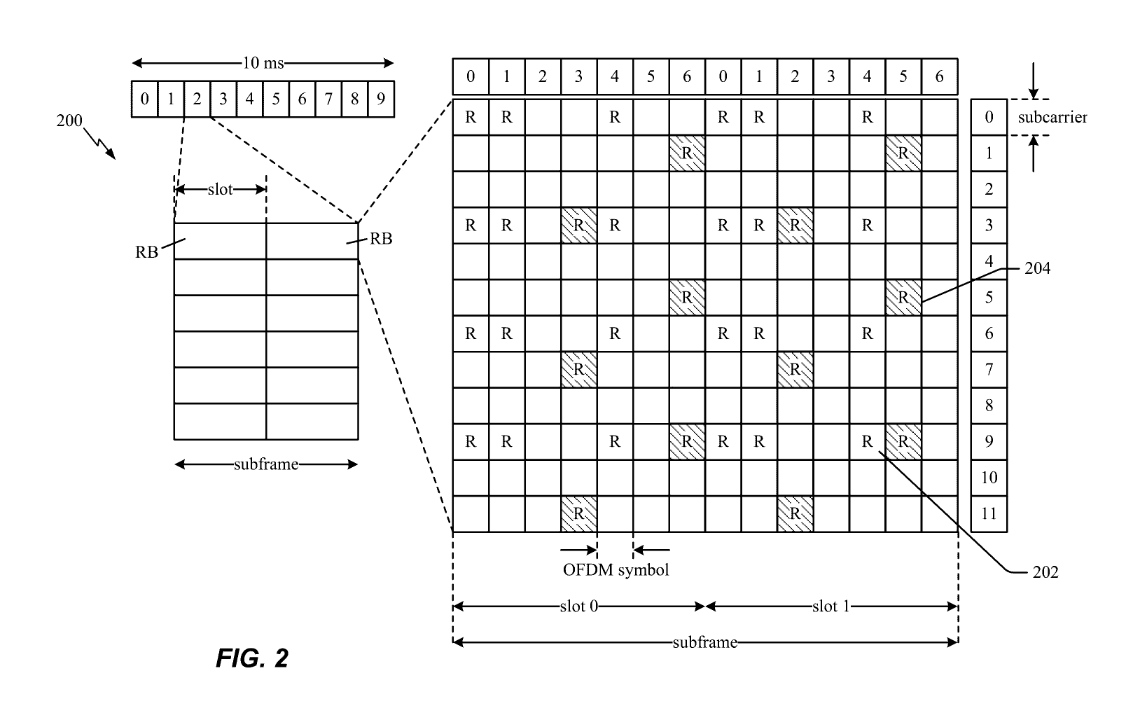

FIG. 2 is a diagram 200 illustrating an example of a downlink frame structure in LTE. A frame (10 ms) may be divided into 10 equally sized subframes. Each subframe may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. Some of the resource elements, as indicated as R 202, 204, include downlink reference signals (DL-RS). The DL-RS include Cell-specific RS (CRS) (also sometimes called common RS) 202 and UE-specific RS (UE-RS) 204. UE-RS 204 are transmitted only on the resource blocks upon which the corresponding physical downlink shared channel (PDSCH) is mapped. The number of bits carried by each resource element depends on the modulation scheme. Thus, the more resource blocks that a UE receives and the higher the modulation scheme, the higher the data rate for the UE.

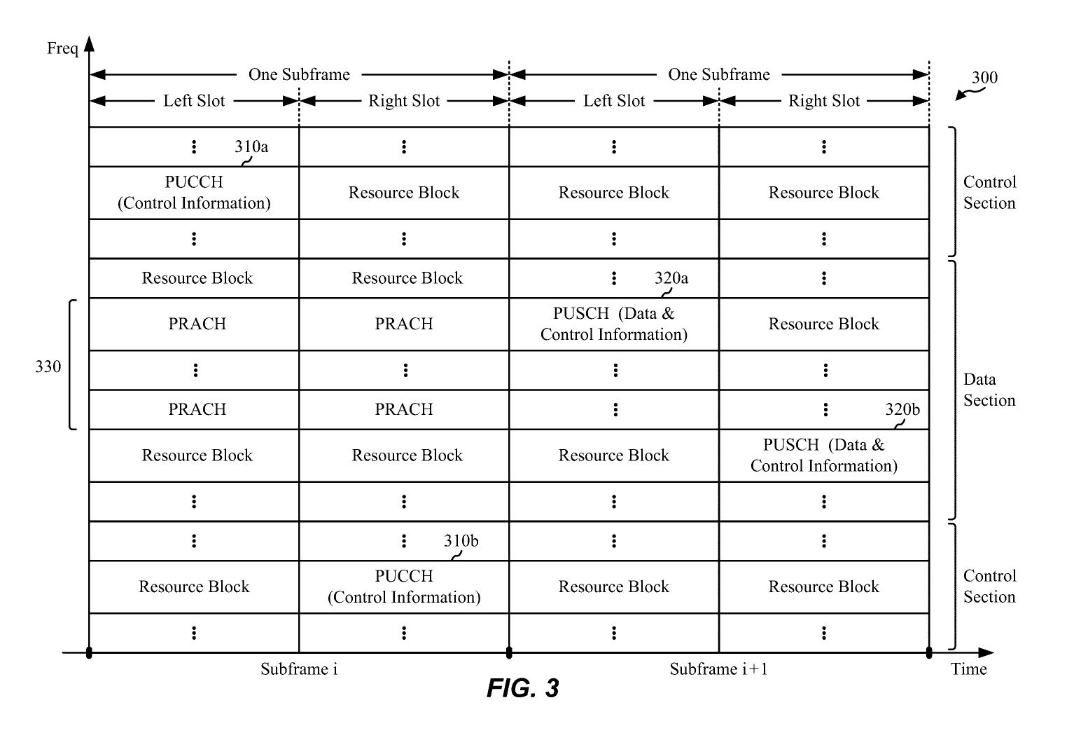

FIG. 3 is a diagram 300 illustrating an example of an uplink frame structure in LTE. The available resource blocks for the uplink may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The uplink frame structure results in the data section including contiguous subcarriers, which may allow a single UE to be assigned all of the contiguous subcarriers in the data section.

A UE may be assigned resource blocks 310a, 310b in the control section to transmit control information to an eNodeB. The UE may also be assigned resource blocks 320a, 320b in the data section to transmit data to the eNodeB. The UE may transmit control information in a physical uplink control channel (PUCCH) on the assigned resource blocks in the control section. The UE may transmit only data or both data and control information in a physical uplink shared channel (PUSCH) on the assigned resource blocks in the data section. An uplink transmission may span both slots of a subframe and may hop across frequency.

A set of resource blocks may be used to perform initial system access and achieve uplink synchronization in a physical random access channel (PRACH) 330. The PRACH 330 carries a random sequence and cannot carry any uplink data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

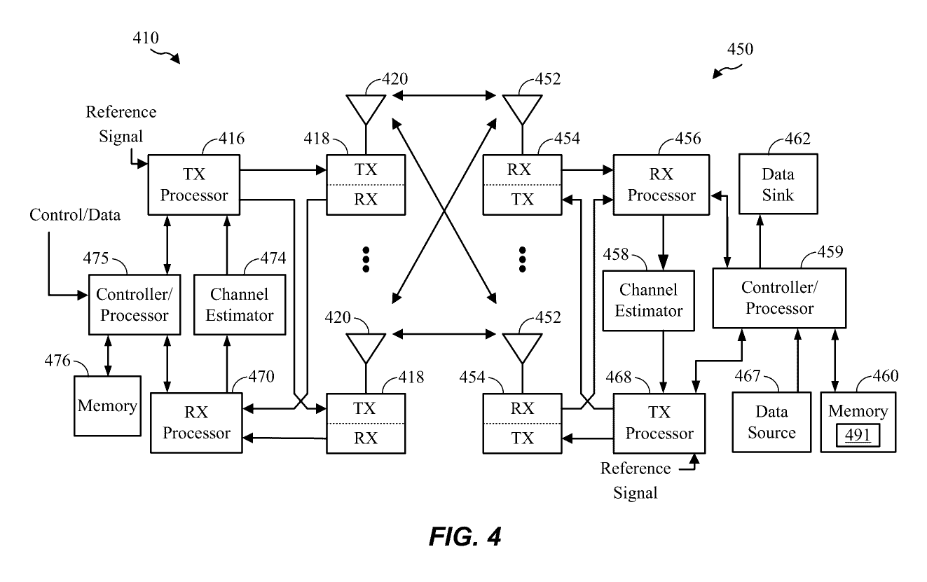

FIG. 4 is a block diagram of a base station (e.g., eNodeB or node B) 410 in communication with a UE 450 in an access network. In the downlink, upper layer packets from the core network are provided to a controller/processor 475. The controller/processor 475 implements the functionality of the L2 layer. In the downlink, the controller/processor 475 provides header compression, ciphering, packet segmentation and reordering, multiplexing between logical and transport channels, and radio resource allocations to the UE 450 based on various priority metrics. The controller/processor 475 is also responsible for HARQ operations, retransmission of lost packets, and signaling to the UE 450.

The TX processor 416 implements various signal processing functions for the L1 layer (i.e., physical layer). The signal processing functions includes coding and interleaving to facilitate forward error correction (FEC) at the UE 450 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 474 may be used to determine the coding and modulation scheme, as well as for spatial processing. The channel estimate may be derived from a reference signal and/or channel condition feedback transmitted by the UE 450. Each spatial stream is then provided to a different antenna 420 via a separate transmitter (TX) 418. Each transmitter (TX) 418 modulates a radio frequency (RF) carrier with a respective spatial stream for transmission.

At the UE 450, each receiver (RX) 454 receives a signal through its respective antenna 452. Each receiver (RX) 454 recovers information modulated onto an RF carrier and provides the information to the receiver (RX) processor 456. The RX processor 456 implements various signal processing functions of the L1 layer. The RX processor 456 performs spatial processing on the information to recover any spatial streams destined for the UE 450. If multiple spatial streams are destined for the UE 450, they may be combined by the RX processor 456 into a single OFDM symbol stream. The RX processor 456 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the base station 410. These soft decisions may be based on channel estimates computed by the channel estimator 458. The soft decisions are then decoded and deinterleaved to recover the data and control signals that were originally transmitted by the base station 410 on the physical channel. The data and control signals are then provided to the controller/processor 459.

The controller/processor 459 implements the L2 layer. The controller/processor can be associated with a memory 460 that stores program codes and data. The memory 460 may be referred to as a computer-readable medium. In the uplink, the controller/processor 459 provides demultiplexing between transport and logical channels, packet reassembly, deciphering, header decompression, control signal processing to recover upper layer packets from the core network. The upper layer packets are then provided to a data sink 462, which represents all the protocol layers above the L2 layer. Various control signals may also be provided to the data sink 462 for L3 processing. The controller/processor 459 is also responsible for error detection using an acknowledgement (ACK) and/or negative acknowledgement (NACK) protocol to support HARQ operations.

In the uplink, a data source 467 is used to provide upper layer packets to the controller/processor 459. The data source 467 represents all protocol layers above the L2 layer. Similar to the functionality described in connection with the downlink transmission by the base station 410, the controller/processor 459 implements the L2 layer for the user plane and the control plane by providing header compression, ciphering, packet segmentation and reordering, and multiplexing between logical and transport channels based on radio resource allocations by the base station 410. The controller/processor 459 is also responsible for HARQ operations, retransmission of lost packets, and signaling to the base station 410.

Channel estimates derived by a channel estimator 458 from a reference signal or feedback transmitted by the base station 410 may be used by the TX processor 468 to select the appropriate coding and modulation schemes, and to facilitate spatial processing. The spatial streams generated by the TX processor 468 are provided to different antenna 452 via separate transmitters (TX) 454. Each transmitter (TX) 454 modulates an RF carrier with a respective spatial stream for transmission.

The uplink transmission is processed at the base station 410 in a manner similar to that described in connection with the receiver function at the UE 450. Each receiver (RX) 418 receives a signal through its respective antenna 420. Each receiver (RX) 418 recovers information modulated onto an RF carrier and provides the information to a RX processor 470. The RX processor 470 may implement the L1 layer.

The controller/processor 475 implements the L2 layer. The controller/processor 475 and 459 can be associated with memories 476 and 460, respectively that store program codes and data. For example, the controller/processors 475 and 459 may provide various functions including timing, peripheral interfaces, voltage regulation, power management, and other control functions. The memories 476 and 460 may be referred to as a computer-readable media. For example, the memory 460 of the UE 450 may store a wireless communication module 491 which, when executed by the controller/processor 459, configures the UE 450 to perform aspects of the present disclosure.

In the uplink, the controller/processor 475 provides demultiplexing between transport and logical channels, packet reassembly, deciphering, header decompression, control signal processing to recover upper layer packets from the UE 450. Upper layer packets from the controller/processor 475 may be provided to the core network. The controller/processor 475 is also responsible for error detection using an ACK and/or NACK protocol to support HARQ operations.

Handover or cell reselection may be performed when the UE moves from a coverage area of a first RAT to the coverage area of a second RAT, or vice versa. A handover or cell reselection may also be performed when there is a coverage hole or lack of coverage in one network or when there is traffic balancing between a first RAT and the second RAT networks. As part of that handover or cell reselection process, while in a connected mode with a first system (e.g., TD-SCDMA) a UE may be specified to perform a measurement of a neighboring cell (such as LTE cell). For example, the UE may measure the neighbor cells of a second network for signal strength, frequency channel, and base station identity code (BSIC). The UE may then connect to the strongest cell of the second network. Such measurement may be referred to as inter radio access technology (IRAT) measurement.

The UE may send a serving cell a measurement report indicating results of the IRAT measurement performed by the UE. The serving cell may then trigger a handover of the UE to a new cell in the other RAT based on the measurement report. The measurement may include a serving cell signal strength, such as a received signal code power (RSCP) for a pilot channel (e.g., primary common control physical channel (PCCPCH)). The signal strength is compared to a serving system threshold. The serving system threshold can be indicated to the UE through dedicated radio resource control (RRC) signaling from the network. The measurement may also include a neighbor cell received signal strength indicator (RSSI). The neighbor cell signal strength can be compared with a neighbor system threshold. Before handover or cell reselection, in addition to the measurement processes, the base station IDs (e.g., BSICs) are confirmed and re-confirmed.

### Buffer Status Reporting During Call Setup for Multimedia Service

The IP multimedia subsystem (IMS) is a framework supporting services that deliver voice communications and multimedia sessions over internet protocol (IP) networks. The voice communications and multimedia sessions may include services such as video telephony, video on demand (VOD), push-to-talk (a.k.a. press-to-transmit), Presence and Messaging, voice-over IP, video-over IP, voice-over LTE (VoLTE), video-over LTE (ViLTE), etc. The IMS may use a session initiation protocol (SIP) and session description protocol (SDP) for session control and multimedia negotiations. Additionally, the IMS may support OTC (over the top content) services operating independent of a 4G (e.g., LTE) network. Examples of OTC services include, but are not limited to, Sky Pat, We Chat and FaceTime.

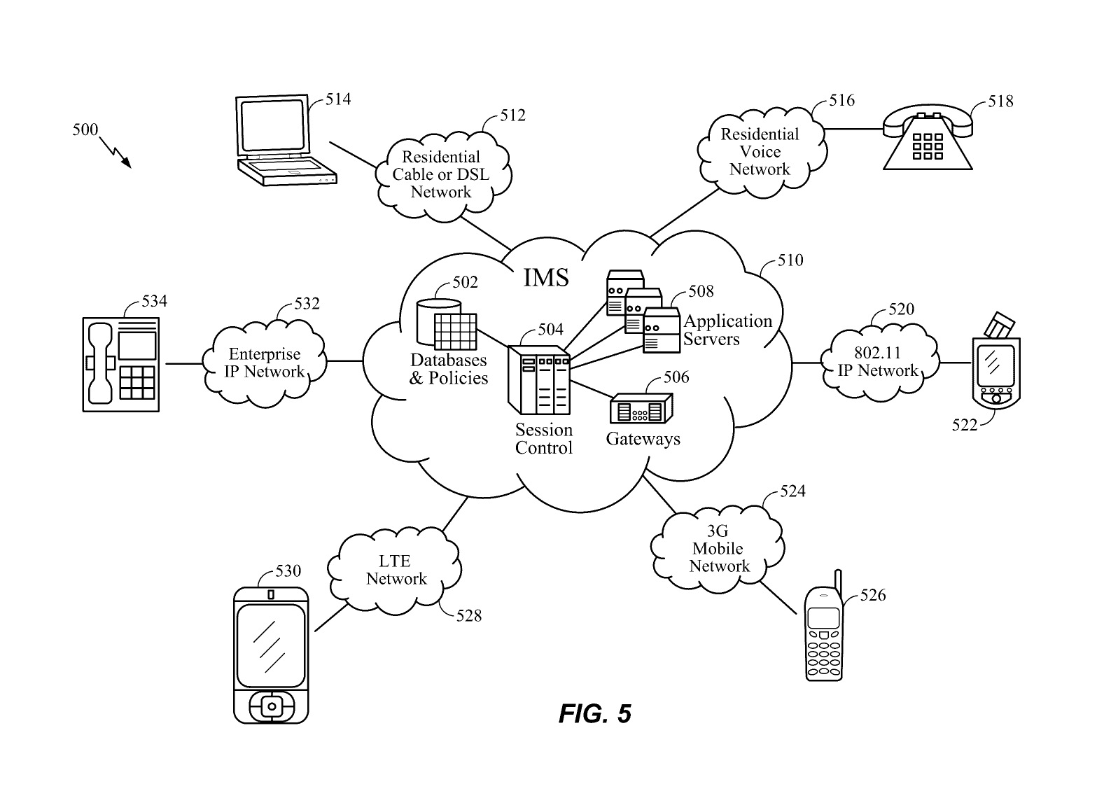

FIG. 5 illustrates an example block diagram of an IMS architecture 500 for multimedia services, including voice communications, video communications and other multimedia sessions. The IP multimedia subsystem (IMS) 510 may include various hardware components such as, but not limited to, databases 502, gateways 506, servers 508 and session control hardware 504. Various networks may be utilized by users and their devices to access the IMS 510. For example, residential cable or DSL (digital subscriber line) networks 512 may connect a laptop user 514 to the IMS 510. Further, a residential voice network 516 may connect a user via a residential landline phone 518 to the IMS 510. In another example, an 802.11 IP network 520 connects a user to the IMS 510 via a device 522. In one example, the device 522 may be a smart phone or table. Additionally, a 3G compatible device 526 connects via a 3G mobile network 524 to the IMS 510. Additionally, an LTE compatible device 530 connects a user to the IMS 510 via an LTE network 528. Further, an IP network compatible device 534 may connect a user to the IMS 510 via and enterprise IP network 532.

Voice-over IP (VoIP) in a 4G/3G network refers to the setup of voice sessions over IP networks between the user equipment (UE) and the operator's IP service network. Although aspects of the present disclosure are discussed with respect to VoIP, the aspects are intended to cover all multimedia services over IP networks, including voice communications, video communications and other multimedia sessions. During a VoIP call setup procedure, the UE (e.g., a “calling” UE or a “called” UE) may set up multiple radio access bearers (RABs) for voice, IMS signaling, PS (packet-switched) data and video with different QoS (quality of service) requirements. Further, it is noted the multiple RABs work independent of each other.

In a VoIP call setup procedure, data inactivity refers to a time period in which no data is exchanged between a user equipment and the network. A data inactivity timer may be utilized to measure the amount of inactivity in a pre-defined time period. During a VoIP (e.g., VoLTE) call setup procedure, when the data inactivity timer expires the UE is put into idle mode to stop monitoring grant channels, thereby preserving the UE battery. The data inactivity timer may be set to a short value to save and preserve the UE battery. For example, when there is no data activity, and the data inactivity timer expires, a PS (packet-switched) network places the UE into idle mode via RRC (radio resource control) connection release. Later, when signaling messages arrive, the PS network pages the UE and places the UE in a connected mode. The signaling messages are then delivered to the UE. Although this process may preserve the battery life of a UE, the same process also increases call setup latency for multimedia servicing over an IP network (e.g., VoIP, VoLTE, etc.). Such a problem is compounded when multiple RABs are established, as any one of the RABs could trigger entry into idle mode.

Aspects of the present disclosure are directed to reducing VoIP call setup latency. In particular, aspects are directed to preventing the inactivity timer from expiring during a multi-call setup, and thereby preventing the base station from putting the UE in idle mode. In some aspects of the present disclosure, a UE tracks and records data inactivity timer values for later use during a subsequent multi-call setup. During a subsequent call setup, the user may access the stored timer values to know when the data inactivity timer will expire. Before the timer expires, the user may send a message to the network to prevent the timer from expiring, thereby preventing the user from entering idle mode.

In one aspect, prior to (or during) a call setup procedure, a user, such as a UE, records and stores data inactivity timer values. The inactivity timer values may be stored in a historical database. Further, the stored timer values may be based on historical data and may represent historical averages of inactivity timer values. Additionally, the data may be stored within a memory of the UE. Further, the expiration time of the data inactivity timer is specific for each cell identification (ID) and tracking area. Accordingly, the timer values may be stored by the UE along with corresponding identifying information. For example, in one aspect the data inactivity corresponds to a global LTE ID (a global cell identifier), a TAC (tracking area code) and/or a public land mobile network (PLMN) ID of each particular cell associated with the data inactivity timer. Further, the data inactivity timer may correspond to an average of data inactivity timers within a tracking area or PLMN ID.

Later, during a subsequent call setup procedure, the UE may access the database of stored data inactivity timer values. When the UE determines that the time period of the current call setup is close to the expiration value of the known (e.g., stored) data inactivity timer, the data UE may send a scheduling request and a non-zero buffer status to the network before the data inactivity timer actually expires. When the network receives the scheduling request, the timer is reset. Once the timer is reset, the timer does not expire, which effectively prevents the network from putting the UE in idle mode and thus avoids the potential VoIP call setup delay.

The non-zero buffer status may be sent regardless of the actual buffer status, even when there is no data in the UE buffer. In one aspect, any value (other than zero) is indicated in the non-zero buffer status report. Additionally, in another aspect, the value of the non-zero buffer status may be based on a predicted amount of data for signaling multimedia data (e.g., voice or video) during a call setup. Optionally, the value indicated in the non-zero buffer status may be based on a predicted amount of data for expected packet data transmissions.

In another aspect, during (or prior to) a multi-call setup procedure, the UE determines whether there is any data in the data buffer. When the UE determines that the UE has no data in the data buffer, the UE sends a first scheduling request and a non-zero buffer status of the data buffer before the data inactivity timer expires. The data inactivity timer may be based on a predicted inactivity timer and/or a recorded inactivity timer. For example, if the UE has never visited a particular cell, the UE may predict the timer value based on other timer values, such as by averaging other timer values from other cells. If the UE had previously visited the cell, the UE can use the inactivity timer that was previously noted for that particular cell. Additionally, the UE may send a second scheduling request and a second buffer status based on an actual condition (including the actual amount) of the data buffer after the call setup is complete. Optionally, the UE may send the second scheduling request during call setup.

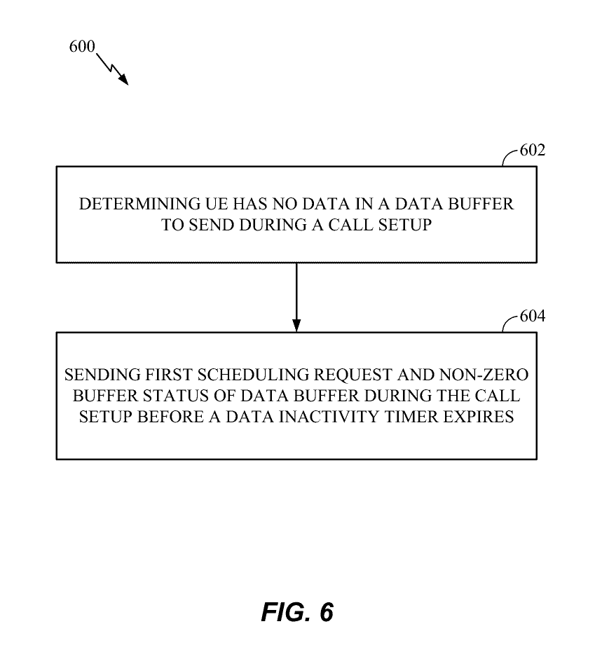

FIG. 6 shows a wireless communication method 600 according to one aspect of the disclosure. At block 602, a user equipment (UE) determines the UE has no data in a data buffer to send during a call setup. At block 604, the UE sends a first scheduling request and a non-zero buffer status during the call setup before a data inactivity timer expires.

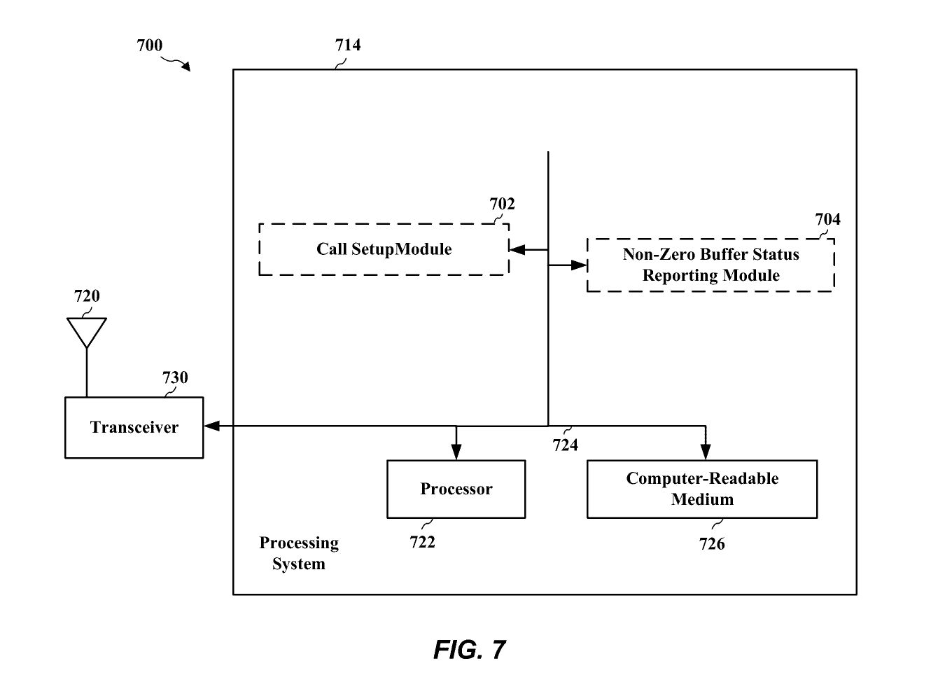

FIG. 7 is a diagram illustrating an example of a hardware implementation for an apparatus 700 employing a processing system 714. The processing system 714 may be implemented with a bus architecture, represented generally by the bus 724. The bus 724 may include any number of interconnecting buses and bridges depending on the specific application of the processing system 714 and the overall design constraints. The bus 724 links together various circuits including one or more processors and/or hardware modules, represented by the processor 722 the modules 702, 704, and the non-transitory computer-readable medium 726. The bus 724 may also link various other circuits such as timing sources, peripherals, voltage regulators, and power management circuits, which are well known in the art, and therefore, will not be described any further.

The apparatus includes a processing system 714 coupled to a transceiver 730. The transceiver 730 is coupled to one or more antennas 720. The transceiver 730 enables communicating with various other apparatus over a transmission medium. The processing system 714 includes a processor 722 coupled to a non-transitory computer-readable medium 726. The processor 722 is responsible for general processing, including the execution of software stored on the computer-readable medium 726. The software, when executed by the processor 722, causes the processing system 714 to perform the various functions described for any particular apparatus. The computer-readable medium 726 may also be used for storing data that is manipulated by the processor 722 when executing software.

The processing system 714 includes a call setup module 702 for determining a UE has no data buffer to send during a call setup. The processing system 714 also includes a non-zero buffer status reporting module 704 for sending a first scheduling request and a non-zero buffer status of the data buffer during the call setup before a data inactivity timer expires. The modules 702 and 704 may be software modules running in the processor 722, resident/stored in the computer-readable medium 726, one or more hardware modules coupled to the processor 722, or some combination thereof. The processing system 714 may be a component of the UE 450 of FIG. 4 and may include the memory 460, and/or the controller/processor 459.

In one configuration, an apparatus such as a UE 450 is configured for wireless communication including means for determining In one aspect, the determining means may be the controller/processor 459, the memory 460, the wireless communication module 491, the call setup module 702, and/or the processing system 714 configured to perform the aforementioned means. In one configuration, the means functions correspond to the aforementioned structures. In another aspect, the aforementioned means may be a module or any apparatus configured to perform the functions recited by the aforementioned means.

The UE 450 is also configured to include means for sending. In one aspect, the sending means may include the antennas 452, the transmitter 454, the transmitter processor 468, the controller/processor 459, the memory 460, the non-zero buffer status reporting module 704, and/or the processing system 714 configured to perform the functions recited by the sending means. In one configuration, the means and functions correspond to the aforementioned structures. In another aspect, the aforementioned means may be a module or any apparatus configured to perform the functions recited by the searching means.

Several aspects of a telecommunications system has been presented with reference to LTE, TD-SCDMA and GSM systems. As those skilled in the art will readily appreciate, various aspects described throughout this disclosure may be extended to other telecommunication systems, network architectures and communication standards, including those with high throughput and low latency such as 4G systems, 5G systems and beyond. By way of example, various aspects may be extended to other UMTS systems such as W-CDMA, high speed downlink packet access (HSDPA), high speed uplink packet access (HSUPA), high speed packet access plus (HSPA+) and TD-CDMA. Various aspects may also be extended to systems employing long term evolution (LTE) (in FDD, TDD, or both modes), LTE-Advanced (LTE-A) (in FDD, TDD, or both modes), CDMA2000, evolution-data optimized (EV-DO), ultra mobile broadband (UMB), IEEE 802.11 (WiFi), IEEE 802.16 (WiMAX), IEEE 802.20, ultra-wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the term “signal quality” is non-limiting. Signal quality is intended to cover any type of signal metric such as received signal code power (RSCP), reference signal received power (RSRP), reference signal received quality (RSRQ), received signal strength indicator (RSSI), signal to noise ratio (SNR), signal to interference plus noise ratio (SINR), etc.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for wireless communications at a user equipment (UE), the method comprising:
determining the UE has no data in a data buffer to send during a call setup; and
sending a first scheduling request and a non-zero buffer status for the data buffer during the call setup before a data inactivity timer expires.

2. The method of claim 1, further comprising sending the first scheduling request before the data inactivity timer expires, in which a data inactivity timer is one of a predicted inactivity timer and a recorded inactivity timer.

3. The method of claim 2, in which a data inactivity timer corresponds to a global cell identifier.

4. The method of claim 2, in which a data inactivity timer corresponds to an average of the data inactivity timers within a tracking area or a public land mobile network (PLMN) ID.

5. The method of claim 1, in which the call setup is for voice-over wireless local area network (WLAN), video-over WLAN, voice-over LTE (VoLTE) or video-over LTE (ViLTE).

6. The method of claim 5, further comprising setting the non-zero buffer status to a value based at least in part on a predicted amount of data for signaling voice or video during the call setup.

7. The method of claim 5, further comprising setting the non-zero buffer status to a value based at least in part on a predicted amount of data for expected packet data transmissions.

8. The method of claim 1, further comprising sending a second scheduling request and a second buffer status based at least in part on an actual condition of the data buffer after the call setup.

9. An apparatus for wireless communications at a user equipment (UE), comprising:
a memory; and
at least one processor coupled to the memory, the at least one processor being configured:
to determine the UE has no data in a data buffer to send during a call setup; and
to send a first scheduling request and a non-zero buffer status for the data buffer during the call setup before a data inactivity timer expires.

10. The apparatus of claim 9, in which the at least one processor is further configured to send the first scheduling request before the data inactivity timer expires, in which a data inactivity timer is one of a predicted inactivity timer and a recorded inactivity timer.

11. The apparatus of claim 10, in which a data inactivity timer corresponds to a global cell identifier.

12. The apparatus of claim 10, in which a data inactivity timer corresponds to an average of the data inactivity timers within a tracking area or a public land mobile network (PLMN) ID.

13. The apparatus of claim 9, in which the call setup is for voice-over wireless local area network (WLAN), video-over WLAN, voice-over LTE (VoLTE) or video-over LTE (ViLTE).

14. The apparatus of claim 13, in which the at least one processor is further configured to set the non-zero buffer status to a value based at least in part on a predicted amount of data for signaling voice or video during the call setup.

15. The apparatus of claim 13, in which the at least one processor is further configured to set the non-zero buffer status to a value based at least in part on a predicted amount of data for expected packet data transmissions.

16. The apparatus of claim 9, in which the at least one processor is further configured to send a second scheduling request and a second buffer status based at least in part on an actual condition of the data buffer after the call setup.

17. A computer program product for wireless communication at a user equipment (UE) in a wireless network, comprising:
a non-transitory computer-readable medium having non-transitory program code recorded thereon, the program code comprising:
program code to determine the UE has no data in a data buffer to send during a call setup; and
program code to send a first scheduling request and a non-zero buffer status for the data buffer during the call setup before a data inactivity timer expires.

18. The computer program product of claim 17, further comprising program code to send the first scheduling request before the data inactivity timer expires, in which a data inactivity timer is one of a predicted inactivity timer and a recorded inactivity timer.

19. The computer program product of claim 17, in which the call setup is for voice-over wireless local area network (WLAN), video-over WLAN, voice-over LTE (VoLTE) or video-over LTE (ViLTE).

20. The computer program product of claim 19, and further comprising setting the non-zero buffer status to a value based at least in part on a predicted amount of data for signaling voice or video during the call setup.

21. The computer program product of claim 19, further comprising setting the non-zero buffer status to a value based at least in part on a predicted amount of data for expected packet data transmissions.

22. The computer program product of claim 17, further comprising sending a second scheduling request and a second buffer status based at least in part on an actual condition of the data buffer after the call setup.

23. An apparatus for wireless communication at a user equipment (UE), comprising:
means for determining the UE has no data in a data buffer to send during a call setup; and
means for sending a first scheduling request and a non-zero buffer status for the data buffer during the call setup before a data inactivity timer expires.

24. The apparatus of claim 23, further comprising sending the first scheduling request before the data inactivity timer expires, in which a data inactivity timer is one of a predicted inactivity timer and a recorded inactivity timer.

25. The apparatus of claim 24, in which a data inactivity timer corresponds to a global cell identifier.

26. The apparatus of claim 24, in which a data inactivity timer corresponds to an average of the data inactivity timers within a tracking area or a public land mobile network (PLMN) ID.

27. The apparatus of claim 23, in which the call setup is for voice-over wireless local area network (WLAN), video-over WLAN, voice-over LTE (VoLTE) or video-over LTE (ViLTE).

28. The apparatus of claim 27, further comprising setting the non-zero buffer status to a value based at least in part on a predicted amount of data for signaling voice or video during the call setup.

29. The apparatus of claim 27, further comprising setting the non-zero buffer status to a value based at least in part on a predicted amount of data for expected packet data transmissions.

30. The apparatus of claim 23, further comprising sending a second scheduling request and a second buffer status based at least in part on an actual condition of the data buffer after the call setup.
